(19) United States
(12) Patent Application Publication
(10) Pub. No.: US 2020/0288755 A1
(43) Pub. Date: Sep. 17, 2020

(54) Radiative Heating and/or Sterilization of Fluid by Infra-red and other Electromagnetic Energy Sources

(71) Applicant: Ignas Samuel Christie, Clay, NY (US)

(72) Inventor: Ignas Samuel Christie, Clay, NY (US)

(21) Appl. No.: 16/788,576

(22) Filed: Feb. 12, 2020

Related U.S. Application Data
(60) Provisional application No. 62/818,231, filed on Mar. 14, 2019.

(51) Int. Cl. A23L 3/005; A23L 3/01; A23L 3/28

(52) U.S. Cl. CPC A23L 3/0055; A23L 3/28; A23L 3/01

(57) ABSTRACT

The present invention relates to a method and equipment intended to heat or sterilize liquid such as water, milk, broth, sauces, juices and similar foods and other fluids used in pharmaceutical and cosmetic applications. More specifically this describes a novel approach for continuously heating liquid food or liquid using an electro-magnetic (EM) radiation such as infra-red and other EM radiation sources. It achieves this by conveying radiation from a remote or local source and directing the radiation onto liquid dispersed into tiny droplets in a chamber. Infra-red and other EM radiations have a limitation in that the penetration depth of energy into the product/liquid is very short. Thus, product can be heated only in a thin layer near the periphery surface where the energy strikes. By dispersing liquid in drop droplets, the radiation effectively penetrates the whole body of fluid and consequently heats and destroys bacteria and some spores. The processed fluid then is commercially sterile or has much lower microbial load and hence it has a longer shelf life, under refrigeration.

This application claims the benefit of the filing date of U. S. Provisional Patent application No. 62/818231, filed on Mar. 14, 2019, titled “Radiative Heating of Dispersed Liquid by Remote Infra-Red and other Electro-magnetic Energy Sources”, the entirety of which provisional application is incorporated by reference therein.

### FIELD OF INVENTION

The present invention relates to heating of fluids by electromagnetic (EM) radiation. More particularly, it relates to use of infrared and other EM radiations in continuously heating of milk, water, juices and similar liquid foods and other fluids used in other fields such as pharmaceutical and cosmetic.

### BACKGROUND OF THE INVENTION

Liquids such as milk are heated in a process called pasteurization primarily in order to make them safe for public consumption. This object is achieved by heating liquids to a certain temperature and holding at such temperature for a certain time in order to kill microorganisms of public health concern. Heating also destroys other forms of bacteria and spores which would otherwise limit shelf life of such food. More intense methods such as Ultra High Temperature (UHT) treatments can remove more microorganisms to bring the number of microbes to such a low level so that product can be kept in good conditions for several days with or without refrigeration. Thermal treatments such as UHT employs a very high temperatures and this has detrimental effects on the quality of food. Consequently, efforts have been continuously made to devise a process that destroys maximum number of microbes but has minimum detrimental effects on quality of food product and maintaining freshness of food.

One way of minimizing undesirable effects on nutritional quality of food and still remove unwanted microbes is use of EM radiation and waves such as microwaves, infrared (IR), Ultraviolet (UV) have been employed for this purpose. Many attempts have been made previously to heat liquid and liquid foods by infrared and other EM radiation.

Because of shorter wavelength, IR has much higher energy than longer wavelength radiation such as microwave. This is true for IR especially on the shorter wavelength near the visible EM spectrum such as 0.7 to 10 microns. Because of higher energy level, IR is capable of killing bacteria as well as bacterial spores as recently have been reported. Compared with thermal conductive heating, FIR irradiation was found to be more effective in pasteurizing vegetative bacterial cells. Previous studies have reported the use of IR, especially far-infrared (FIR), for pasteurization. Furthermore, FIR irradiation caused heat activation and death of Bacillus Subtilis spores in a temperature range where spore viability was not affected by thermal conductive heating. In light of this, if liquid can be heated continuously by IR, this would be very beneficial to food processing industry.

In medicine field, many fluids including those of biological origins are introduced into a patient body for therapeutic purposes. Methods must be set in place to substantially eliminate pathogens before these fluids are introduced into bodies while minimizing denaturation of useful components therein during pathogen inactivation process. Use of radiation is very wide for these products and many patents describe such application methods.

Since such radiation do not have capacity to penetrate much deeper through the liquid, there is a possibility that all parts of the liquid flowing would not get radiation uniformly and consistently. Keeping high turbulence can help in this matter, still the thickness of film is usually much more than EM radiation can penetrate. For example, UV rays with 230 nm wavelength can penetrate 75-100 microns before the intensity drops very low. Clearly the tube diameter carrying the fluid across which the radiation impinges, will need to be much larger to be of any practical value especially for commercial scale flow rates.

Thus, short penetration of EM waves is a major limitation of any approach of heating the liquid continuously. This limitation becomes more severe especially in food processing applications where high flow rates of food processing are normally required which make many approaches in previous art impractical.

Use of IR or EM radiative heating is therefore limited to heating solids where a thin solid layer is kept on a flat surface and IR radiation is directed from the space above. Similarly, in continuous system, solids are kept on a continuously moving belt in a box like structure while IR radiation is directed from IR heaters located above. Thus, solids are heated during the time the solids are under the radiation source inside the box. It is obvious that liquid cannot be heated like the solids and this confines the application of IR and other radiation for heating mainly to solids so far as commercial flow rates are concerned.

Further, in a continuous flow process involving EM radiation, the residence time of the fluid in the radiation field is directly related to the amount of energy absorbed by the fluid elements. Therefore, a continuous flow process requires that the distribution of residence times of the fluid elements be as narrow as possible.

Most previous attempts have been through transparent tubes where product is flowing inside tube while radiation is applied from outside the tube. Some have tried passing product through an annular space while radiation coming from outside the annular space and through the transparent tube outside. In one design patent #6010727 (2000) has liquid flowing through 6 mm (0.25 inch) annular space formed by two quartz cylinders where the liquid receives UV radiation to inactivate microbes and then infrared radiation for photo reactivation to improve the organoleptic quality. U.S. Pat. No. 6,576,201 describes a device for sterilization of biological fluid through UV rays. The liquid passes through a narrow space between a cylinder and a rotor. The residence time is controlled by flow rate and rotor speed.

The various previous designs have attempted to remove the limitations by different approaches, there is still a need for a widely applicable and practical method for irradiation method that can be used for processing foods and beverages and for sterilization in pharmaceutical applications.

It is therefore an object of the present invention to provide a continuous flow equipment system and method that is highly effective in uniformly transferring EM radiation energy to fluids having low radiation penetration in a controllable, reliable manner and that is suitable for small as well as high volume flow rates.

The present invention while avoiding disadvantages and limitations of the current approaches, provides a unique method and apparatus for heating liquid with EM radiation for processing of foods and sterilization of biological fluids. The liquid in some cases may be heated or remain unheated as in the case of the so-called cold pasteurization for example.

### SUMMARY OF INVENTION

The current invention describes a method and an equipment for continuously processing/heating liquid food or medicinal fluid using an electro-magnetic (EM) radiation. This is achieved by dispersing the liquid into tiny droplets which move largely under force of gravity and directing the radiation onto these droplets. Infra-red and other EM radiation such as microwave, UV have a limitation in that the penetration depth of energy into the product/fluid is very less. Thus, product can be heated only in a thin layer near the periphery surface where the energy is incident. In a continuous heating system, where the pipe carrying liquid is completely filled, the liquid cannot be heated throughout the volume in pipe as IR cannot be absorbed by the liquid beyond a certain depth from the periphery of piping.

The present invention makes it possible to heat liquid continuously with IR and other EM energies such as microwave and UV. It negotiates the limitation of limited penetration depth of EM radiation by dispersing the liquid into tiny droplets and then directing radiation onto the droplets.

### BRIEF DESCRIPTION OF THE DRAWINGS

The present invention will be more clearly understood with reference to the following detailed description when considered in conjunction with the drawings referenced here.

FIG. 1 shows schematically a cross section of the cylindrical heating chamber with conical bottom. It further shows the fluid entrance, exit and the droplet pattern inside the chamber.

FIG. 2 shows a schematic layout of a typical fluid processing system where the present invention can be used as an improved system.

### DETAILED DESCRIPTION

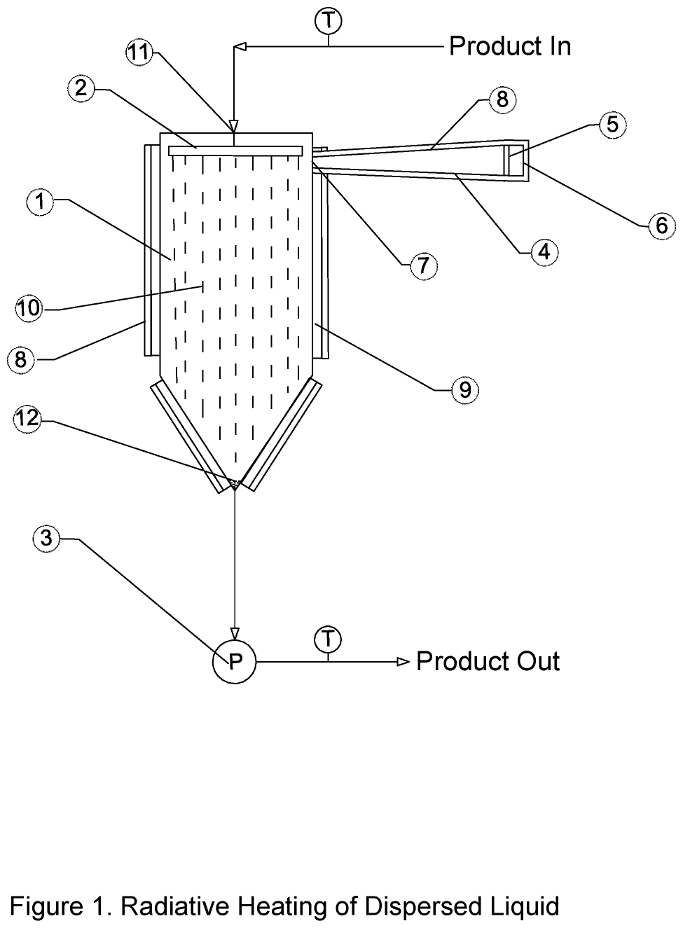

The invention is schematically described with the help of a sketch as shown in FIG. 1. The liquid to be processed is brought to the top of a thin walled vertical cylinder 1 and is fed from top 11 through a disperser 2 and thus a liquid spray of fine particle is created inside the chamber. The cylinder has a conical bottom for removal of heated product which is done by a pump 3. The heating/processing space can be rectangular or other shape that provides space for droplets to travel downwards while heating. The outer wall would preferably be covered with insulation 8 to minimize heat losses from chamber while the jacket 9 through which a medium is circulated at controlled temperature. The temperature of medium in upper jacket is maintained at a level such that inner walls are at or slightly above the temperature of liquid inside the chamber while temperature of medium in lower jacket is maintained at the temperature the outgoing liquid. The temperature of inner wall of the cylinder is maintained to avoid any condensation on the wall. Absence of liquid on inner wall will prevent formation of any drops or liquid film on the inner walls. Droplets or liquid film formed on the wall would absorb the radiation and heat up. These stagnant or slowly moving drops and film will be over exposed to radiative heat and overheated, resulting in possible burns at the wall and more extensive chemical changes in these elements. This will ultimately result in some portion of fluid receiving more energy while some receiving less energy. The current invention avoids this situation by making all fluid droplets going to the bottom only and preventing condensation at inner vertical walls. The jacket over the lower cone helps to avoid over-heating and maintaining temperature of outgoing liquid. Liquid level is maintained at the lower end of conical, thus containing EM radiation inside the chamber space.

Infrared (IR) energy is generated by a heater 5 and a reflector 6 assembly at some distance away from the cylinder. The generated IR energy is conveyed to the chamber wall by a wave guide 4. The inner surface of the wave guide preferably has a mirror finish so as to have a high reflectivity. The inner surface may also have some special coating for increasing reflectivity. The waveguide is insulated for minimizing heat losses. The IR energy is conveyed into chamber space by connecting the other end of wave guide to a high point on vertical wall through a flat window 7 which is transparent to IR or EM radiation. The connection of waveguide may be made at a slight angle downwards to facilitate reflection of energy through the inner walls of cylinder.

For EM radiation other than IR, suitable modification must be made in the design and dimensions of the waveguide 4 based on wavelength of specific EM radiation. Similarly, the flat window 7 must transparent to the EM radiation employed.

The liquid is fed from top 11 through a disperser 2 which typically is a spiral shaped piping with multiple perforations downwards or a trough with multiple perforations. In place of perforations narrow slits facing downwards would also serve the purpose. These perforations may or may not have removable inserts. The intention here is that liquid leaving the disperser creates a multiple of small droplets falling down through the cylinder space under the influence of gravity with a minimum axial velocities and negligible radial velocities. Under these conditions droplets travel down in the direction of the conical section at the bottom and no droplets go to the side walls as shown by flow pattern shape 10. The disperser design is such that almost entire enclosed space is occupied by the spray.

The minimum diameter of droplets is estimated at 1.5 mm for water like fluids but is largely governed by flow rates, pressure drops and properties such as viscosity and surface tension. The minimum particle diameter is thus determined experimentally for any specific fluid. During atomization, very small droplets are formed and these move under influence of two forces, namely gravity force acting downwards while drag force opposing the downward motion. The particle then travels downward with a terminal settling velocity according to Stokes law. The main idea here is that the droplets are just large enough so that the gravitation force is significantly higher than the drag force. For example, for a droplet of 1.5 mm diameter, gravitation forces are about 6 times larger than the drag forces after first second of downward travel. With large droplets as in this invention, the droplets sizes are comparable to one coming from a shower head, where droplets are largely influenced by gravity and fall downwards. The relatively large diameter is also critical because the bacterial kill in droplet is taking place only by interaction with IR/EM radiation energy since no other forces such as internal pressure or shear forces exist in significant level inside the droplet exiting the disperser. Further, the particles do not travel to the side wall of vertical section of the cylinder.

Further, as in the case of spray nozzles or other such devices generally known as atomizers, the atomized particles exhibit a wide range of size distribution. The particles range from a couple of hundreds of microns to a few microns. The intention of atomization, for example in spray drying equipment, is to create a large surface of liquid through which evaporation of liquid takes place almost instantaneously once the liquid comes out of such atomizers. As a result, very fine liquid particles are formed and they travel with a velocity close to terminal settling velocity and a large portion of it also travel to the side walls. It creates a situation where the entire space in the chamber is filled with fine liquid particles that travel to wall and form a film there. Instead of using such fine spraying devices, the present invention employs a disperser which ensures that the liquid particles are large and hence the force of gravity is significantly higher than drag forces, making the particles travel straight downwards largely under the influence of gravity. The disperser is designed to disperse the fluid rather than form a mist as in the case of atomizers.

One important feature that results from the fact that the droplets move largely under gravity is that the invention results in a very narrow residence time distribution for the fluid. This is because, all particles have nearly the same velocities as they all move substantially under gravity as gravity force on droplet is significantly higher than the drag force. This situation is also very different than the flow in pipe wherein all particles move with different velocities and hence have a wide residence time distribution. Even in the previous art, where the flow is moving in annular space, the residence time is wide because of channeling effect.

Further, the air inside chamber will become saturated with solvent (water or any other liquid) at the operating temperature and if the side walls are at a temperature lower than inside temperature, there will be a possibility of some solvent or fluid condensing on the inner wall. Since the temperature of inner walls are maintained at slightly higher temperature, such condensation is avoided. Further, since there is no mist formation and droplets do not go to walls.

As the droplets are falling downwards, IR is incident upon them virtually from all sides, IR gets absorbed by droplet and the liquid temperature increases. Since, the inner walls of cylinder has high reflectivity, radiation not absorbed by droplet is reflected by the wall and it is incident on the droplet again. Thus, there are multiple interactions between droplet and IR radiation by the time droplet reaches bottom. Further, there are numerous air interstices between two neighboring droplets which gives numerous chances for the radiation to reach most droplets. Thus, the whole body of liquid gets access to the radiation effectively penetrating the whole moving body of liquid.

Another advantage of this invention is the way radiation is directed to the liquid droplets. The directly mounted energy source above the product surface as in solids heating requires a large surface. For the arrangement in the present invention, direct mounting of energy source is not necessary and the wave guide also actually focuses the radiation and hence it can be applied only from a relatively small window on the cylinder wall. The radiation is normally reflected and focused because of the shape of wave guide, but it can be optically carried out too. On the other hand, energy source can be mounted directly on the wall through a transparent window if so desired.

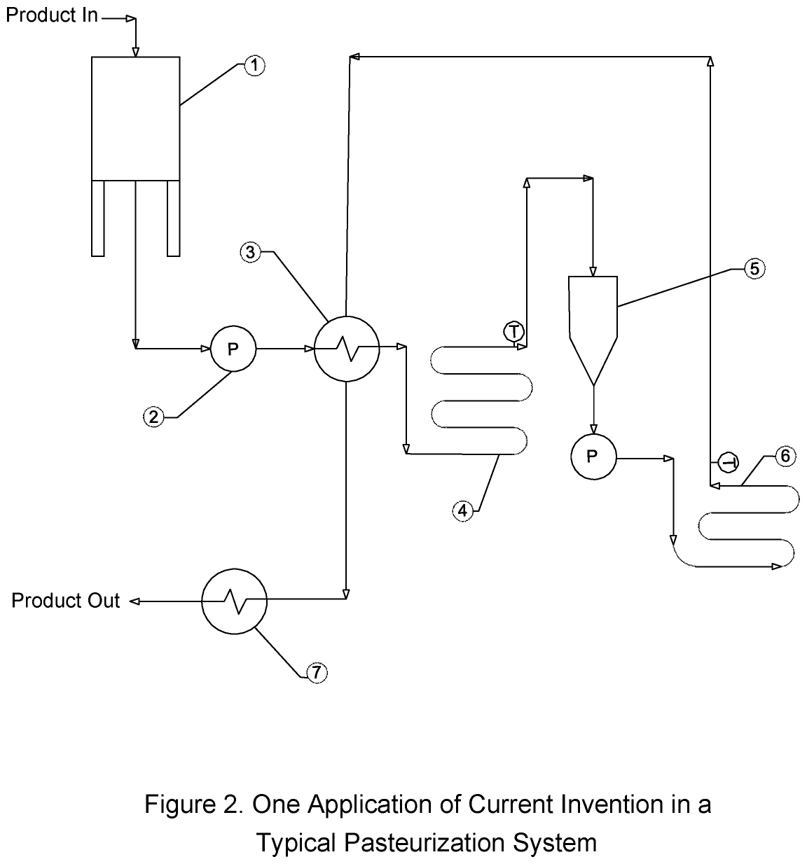

FIG. 2 illustrates one way of using this invention in a pasteurization system for milk or other similar products. Here raw product is allowed in a balance tank 1 from which it is pumped through a heating regenerator 3 and the IR heater 5 (current invention) as described in FIG. 1 and through hold tube 6. From this point, it cools down through regenerator 3 and then final cooling is done in heat exchanger 7 before going to filler or cold storage tank. In certain cases, it may be necessary to hold the milk at a certain temperature and time so as to activate dormant bacterial spores by an additional hold section 4. In this arrangement, the final heating section of a regular pasteurization system such as High Temperature Short Time (HTST) or Higher Heat Shorter Time (HHST) is replaced by the current invention heater, thus, the overall efficiency of the system remains high. Further, the critical control point (CCP) in this arrangement is the hold temperature at hold tube 6, just like conventional HTST system.

The advantage can be further extended by this invention in that Extended Shelf Life (ESL) like quality can be achieved at lower temperature than those used in conventional UHT units where temperature as high as 285−290° F. are used. This is possible because spores can be destroyed by application of high energy of IR and other EM radiation. For example, if milk is heated to a final heating temperature of 195° F. through IR heating by the present invention and held for 30 seconds, the chemical degradation will be only 20% (C* or 3%Thiamin destruction basis) of what would occur at 285° F. holding for 4 seconds which are routinely employed for ESL milk. Thus, this invention has a great potential for increasing shelf life of milk with better nutritional and flavor quality than conventional ESL milk using UHT/aseptic temperature and hold profile.

While the invention has been shown and described with preference to specific preferred embodiments, it should be understood by those skilled in the art that various changes in form and detail may be made therein without departing from the spirit and scope of the invention as defined by the claims here.

What is claimed:

1. A method of continuously heating or sterilizing fluid by electromagnetic radiation comprising:
dispersing a fluid in a closed space into fine droplets so that the radiation can penetrate the droplets from all sides and thus penetrate the whole fluid mass and have multiple chances of impingement or incidence,
dispersing a fluid in fine droplets that are large enough so that they move substantially under the influence of gravity,
dispersing a fluid in fine droplets that are large enough with no fine mist formation,
directing electro-magnetic radiative energy on to the dispersed droplets of fluid in an enclosed space,
heating or sterilizing or treating the fluid as a result of droplet-radiation interaction,
collecting processed fluid from the bottom of enclosed space and taking it away by some means such as a pump.

2. The method of claim 1, wherein infra-red electromagnetic radiation is used for processing fluid

3. The method of claim 1, wherein microwave electromagnetic radiation is used for processing fluid

4. The method of claim 1, wherein ultra-violet electromagnetic radiation is used for processing fluid

5. An apparatus or equipment for continuously heating or sterilizing fluid byinfra-red, microwave, ultraviolet and similar electromagnetic radiation comprising:
a means for dispersing a fluid inside a closed space into fine droplets so that the radiation energy can penetrate the droplets from all sides and thus penetrate the whole fluid mass and have multiple chances of impingement or incidence
a means for dispersing a fluid in fine droplets that are large enough so that they move substantially under the influence of gravity
a means for dispersing a fluid in fine droplets that are large enough with no fine mist formation
a mechanism for directing a focused beam of electro-magnetic radiative energy on to the dispersed droplets of fluid in an enclosed space
a means of collecting processed fluid from the bottom of enclosed space and taking it away such as a pump
an instrumentation and controls arrangement to control the temperatures at various points and flow rates

6. The apparatus of claim 5, where the disperser is in form of series of pipes with holes or perforations

7. The apparatus of claim 5, where the disperser is in form of series of pipes with narrow slits

8. The apparatus of claim 5, where the disperser is in form of trough with holes or perforations

9. The apparatus of claim 5, where the enclosure is rectangular or other shape

10. The apparatus of claim 5, where the mechanism for directing electro-magnetic radiative energy is through a waveguide designed for a radiation involved

11. The apparatus of claim 5, where electro-magnetic radiative energy is directed through a radiation source directly installed on the wall of the chamber through a large transparent window

12. The apparatus of claim 11, where electro-magnetic radiative energy is directed through a radiation source directly installed on the entire periphery of the chamber wall through transparent wall
